(19) United States
(12) Patent Application Publication
(10) Pub. No.: US 2021/0178417 A1
(43) Pub. Date: Jun. 17, 2021

(54) Pressure Nozzle Support

(71) Applicants: Philip David Haglof, Sagamore Beach, MA (US); Joshua Haglof, Sagamore Beach, MA (US); Nicholas Haglof, Sagamore, MA (US)

(72) Inventors: Philip David Haglof, Sagamore Beach, MA (US); Joshua Haglof, Sagamore Beach, MA (US); Nicholas Haglof, Sagamore, MA (US)

(21) Appl. No.: 17/121,644

(22) Filed: Dec. 14, 2020

Related U.S. Application Data
(60) Provisional application No. 62/949,401, filed on Dec. 17, 2019.

(51) Int. Cl. B05B 15/62; B08B 3/02

(52) U.S. Cl. CPC B05B 15/62; B08B 2203/0217; B08B 3/026

(57) ABSTRACT

A pressure nozzle support includes a body. A first and second guide is attached or integral to the body and is formed in a shaped that glides along a vertical surface. A nozzle coupling is attached to the body or integral to the body behind the first and second guides. The nozzle coupling is configured to support a pressure nozzle that provides a stream of pressured fluid in a region between the first and second fixed guide and is positioned at a height above a bottom surface of each of the first and second fixed guides so that a nozzle positioned therein will be at a predetermined distance away from the vertical surface.

### CROSS REFERENCE TO RELATED APPLICATION

The present application is a non-provisional application of U.S. Provisional Patent Application Ser. No. 62/949,401 entitled “Pressure Nozzle Support” filed on Dec. 17, 2019. The entire content of U.S. Provisional Patent Application Ser. No. 62/949,401 is herein incorporated by reference.

The section headings used herein are for organizational purposes only and should not to be construed as limiting the subject matter described in the present application in any way.

### INTRODUCTION

Pressure washers provide a pressurized spray of a cleaning liquid to a surface for the purpose of cleaning or otherwise processing the surface with a pressurized steam of liquid. Pressure washers are commonly used for cleaning large surface areas such as patios and deck. Various nozzles and attachments are used to achieve various pressure washing goals. For example, nozzles can be configured to provide cleaning fluid at a desired pressure. In addition, nozzles can be configured to provide cleaning fluid to the surface with a desired spray pattern. Various attachments are sometimes used to assist the operator in directing the nozzle for particular applications.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates a pressurized fluid delivery apparatus commonly referred to as a pressure washer.

FIG. 2A illustrates one embodiment of a pressure nozzle support for vertical surfaces that includes a ring-shaped body with various components attached according to the present teaching.

FIG. 2B illustrates the pressure nozzle support for vertical surfaces that includes the ring-shaped body of FIG. 2A with a nozzle secured in the nozzle coupling and positioned for pressure washing a vertical surface according to the present teaching.

FIG. 3 illustrates another embodiment of a pressure nozzle support for vertical surfaces that includes a ring-shaped body with various components attached according to the present teaching.

FIG. 4 illustrates one embodiment of a pressure nozzle support for vertical surfaces that includes a triangular-shaped body with various components attached according to the present teaching.

FIG. 5 illustrates an embodiment of a pressure nozzle support for vertical surfaces that includes three arms attached at a first end at a base according to the present teaching.

FIG. 6 illustrates an embodiment of a pressure nozzle support for vertical surfaces that includes three arms attached at a first end at a base and attached at a second end to a body according to the present teaching.

FIG. 7 illustrates an embodiment of a pressure nozzle support for vertical surfaces that includes a frictional bottom surface according to the present teaching.

### DESCRIPTION OF VARIOUS EMBODIMENTS

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings can be performed in any order and/or simultaneously as long as the teaching remains operable. Furthermore, it should be understood that the apparatus and methods of the present teachings can include any number or all of the described embodiments as long as the teaching remains operable.

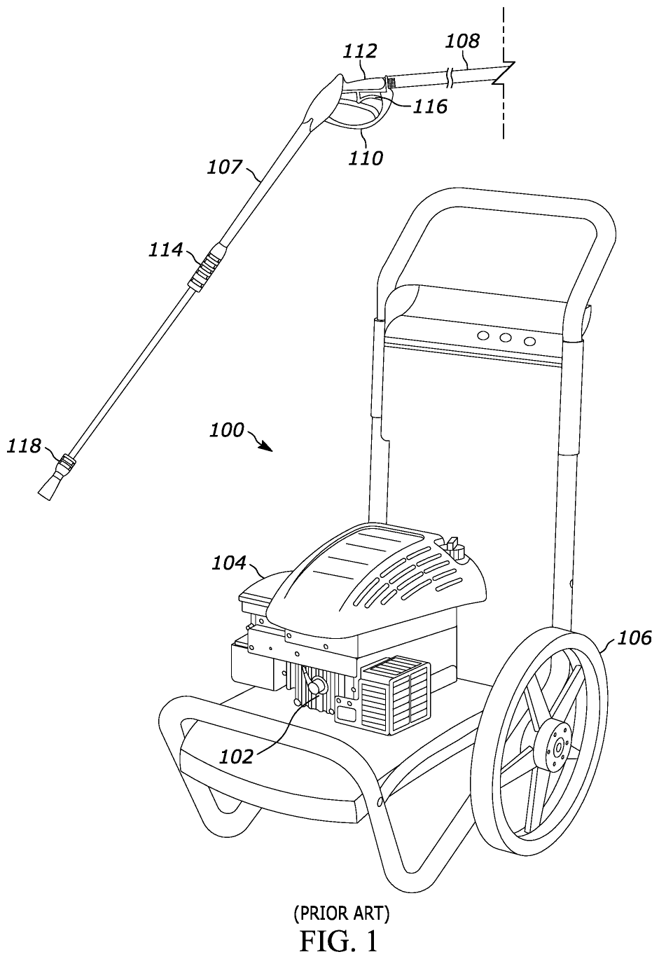

FIG. 1 illustrates a pressurized fluid delivery apparatus which is commonly referred to as a pressure washer 100. The pressure washer 100 includes a power unit 102 that is typically a gas engine or an electric motor. However, numerous other types of power units can be used. Typically, lower pressure units use an electric motor power unit while relatively high-pressure units use a gas power unit. The output of the power unit 102 is coupled to a pump 104. The pump 104 includes an input that is configured to receive a relatively low-pressure steam of liquid and an output that provides a relatively high-pressure stream of liquid. The power unit 102 and the pump 104 may be transportable by a wheeled cart 106. However, the cart 106 is not an essential component of the pressure washer 100.

The output of the pump 104 is typically coupled to what is commonly referred to as a wand 107 by a section of hose 108. That is, one end of the hose 108 is coupled to the output of the pump 104 and the other end of the hose 108 is coupled to the input of the wand 107. Numerous types of fluid couplings can be used to secure the hose 108 to the output of the pump 104. The wand 107 is often a rigid conduit, but can also be a flexible conduit. The wand 107 can have a variable length. For example, the wand 107 can be a telescoping wand. There is often a flow control mechanism between the hose 108 and the input of the wand 107 that allows cleaning fluid to pass from the hose 108 to the wand 107.

The flow control mechanism typically takes the form of a gun assembly 110 and is configured so that the wand 106 is an extension of the gun assembly 110. In many commercial pressure washer systems, the gun assembly 110 includes a hand grip 112 for an operator to grasp with one hand, and a barrel 114 or some other type of hand hold for the operator to grasp with the other hand. A trigger 116 is located near the hand grip 112 to allow the operator to selectively operate the gun assembly 110.

A nozzle 118 is coupled to the output of the wand 107. Numerous types of coupling can be used to form a water tight coupling between the nozzle 118 and the output of the wand 107. For example, the nozzle 118 can be coupled to the output of the wand 107 with a screw-type coupling or with a quick disconnect-type coupling. The nozzle 118 is configured to provide a desired spray pattern to a surface at a particular distance relative to the nozzle 118.

In operation, the power unit 102 drives the pump 104 to produce a pressurized liquid at an output of the pump 104. The pressurized liquid flows from the pump 104 through the hose 108 to the gun assembly 110 where the flow is controlled by the trigger 116, which when activated, allows the fluid to flow through the wand 107 to the nozzle 118 where it flows through the nozzle 118 to the surface to be pressure washed.

Various attachments are sometimes used to assist the operator in directing the nozzle 118 to a desired surface. Some of these attachments support the nozzle 118 at a predetermined distance away from the surface. For example, some known attachments are designed to support the nozzle 118 at a predetermined distance away from a horizontal surface. See, for example, U.S. Pat. No. 7,927,003.

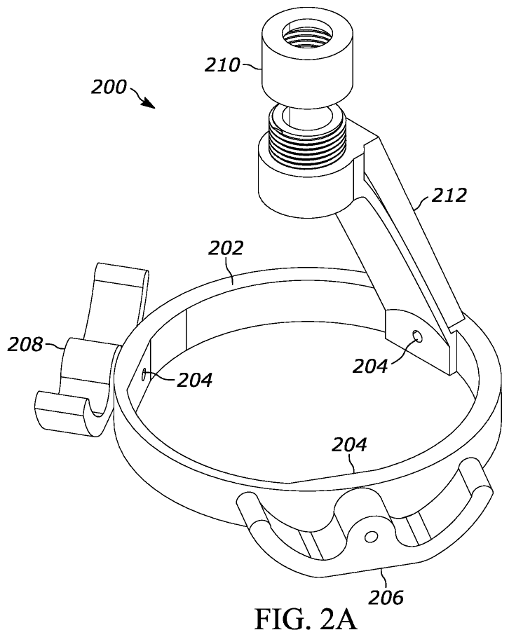

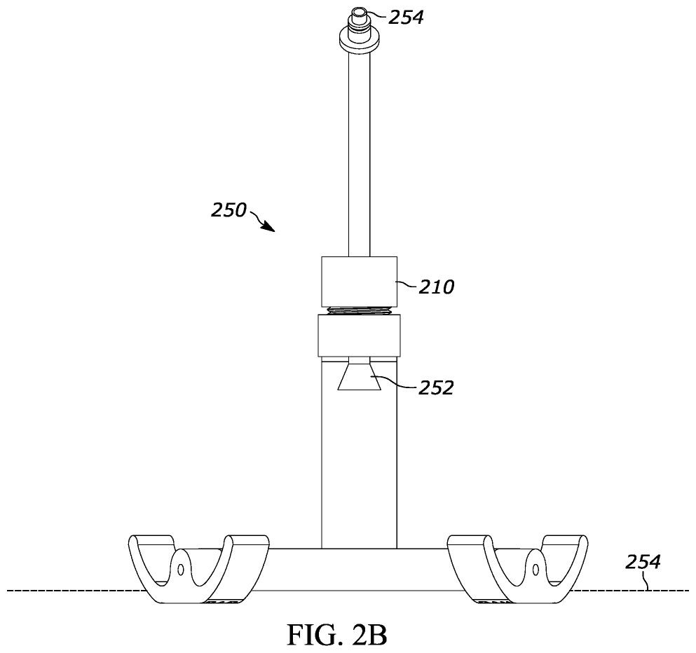

FIG. 2A illustrates one embodiment of a pressure nozzle support 200 for vertical surfaces that includes a ring-shaped body 202 with various components attached. The ring-shaped body 202 includes a plurality of attachment points 204 that can, for example, be an aperture partially or totally through the body 202 that is compatible with various types of fasteners. In the embodiment shown in FIG. 1, the attachment points 204 are through-holes in the body 202 that receive a pin-type or through bolt-type fastener.

A first 206 and second fixed guide 208 are attached to the body 202 at respective attachment points 204. The first and second guides 206, 208 are formed in a shaped that easily glides along a vertical surface during pressure washing operations. For example, in the embodiment shown in FIG. 2A, the first and second guides 206, 208 are “ski”- or “rocker”-shaped with raised ends that are shaped so to easily glide over uneven vertical surfaces during pressure washing conditions.

A nozzle coupling 210 is attached to the body 202 by an arm 212 that is attached at one of the plurality of attachment points 204. In various embodiments, the nozzle coupling 210 is formed directly in the arm 212 or is attached to the arm 212 by one of numerous types of fasteners. The arm 212 is attached to the body 202 adjacent to the first and second fixed guides 206, 208.

The arm 212 is generally configured to extend the nozzle coupling 210 to a position above the ring-shaped body 202. The nozzle coupling is positioned at a height above a bottom surface of each of the first and second fixed guides 206, 208 so that the nozzle supported by the nozzle coupling will be at a predetermined distance away from the vertical surface. In various embodiments, the arm 212 positions the nozzle coupling 210 above the ring-shaped body 202 so that an outlet of a nozzle secured in the nozzle coupling 210 is positioned parallel to the body 202 or at some angle relative to the body 202 where a nozzle secured in the nozzle coupling 210 sprays the pressurize fluid in a desired area on a vertical surface. In many embodiments, the desired area is located within the ring-shaped body 202 and/or between the first and second fixed guide 206, 208.

In the embodiment shown in FIG. 2A, the nozzle coupling 210 is barrel-shaped to accept a cylindrical nozzle and is shaped to firmly holds a nozzle in position during pressure washing operation at high pressure. During normal operation, the body 202 is oriented so that the first and second guides 206, 208 are positioned higher on the vertical surface being pressure washed than the nozzle coupling 210.

FIG. 2B illustrates the pressure nozzle support 250 for vertical surfaces that includes the ring-shaped body of FIG. 2A with a nozzle 252 secured in the nozzle coupling 210 and positioned for pressure washing a vertical surface 254. The pressure nozzle support 250 is identical to the pressure nozzle support 200 described in connection with FIG. 2A that includes the body 202 with attachment points 204, the first and second fixed guides 206, 208, the nozzle coupling 210, and the arm 214. However, the pressure nozzle support 250 also includes a nozzle 252 having an input 254 that is coupled to an output of a pump that produces a pressurized liquid as described in connection with the pressurized fluid delivery apparatus or pressure washer of FIG. 1. The input of the nozzle 254 is coupled to the output of a pump via a fluid conduit, such as a high-pressure hose.

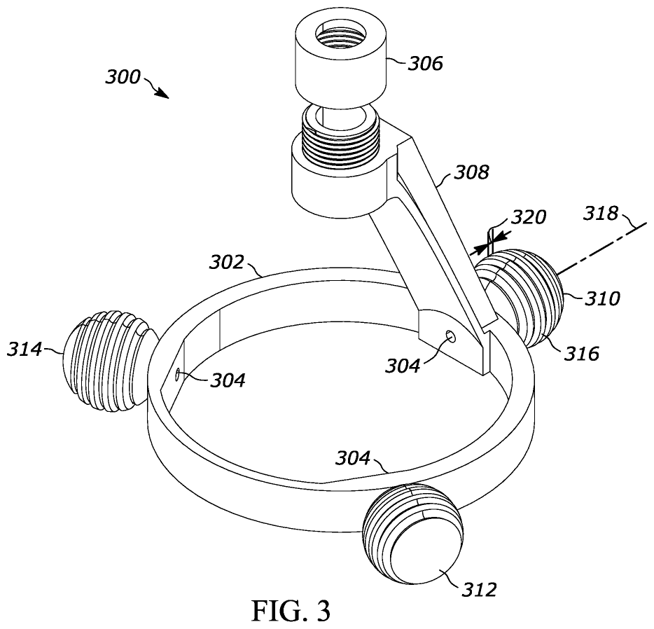

FIG. 3 illustrates another embodiment of a pressure nozzle support 300 for vertical surfaces that includes a ring-shaped body 302 with various components attached. The pressure nozzle support 300 is similar to the pressure nozzle support 200 described in connection with FIG. 2A. Like the pressure nozzle support 200 of FIG. 2, the pressure nozzle support 300 includes a body 302 with attachment points 304, a nozzle coupling 306, and an arm 308. Also, like the pressure nozzle support 200 of FIG. 2, the attachment points 304 are through-holes in the body 202 that receive a pin-type or through bolt fastener.

However, there are a first 310, a second 312, and a third guide 314 that are generally circular or ball shaped. For example, the first 310, second 312, and third guide 314 can be hard rubber balls or hollow core balls that are pressurized. The first 310, second 312, and third guide 314 can be fixed or can allow 360 degrees of motion on the vertical surface. The first 310, second 312, and third guide 314 can even be configured to have omni-directional motion in two or three dimensions. Like the pressure nozzle support 200 of FIG. 2A, the nozzle coupling 306 is positioned at a height above a bottom surface of each of the first, second and third guides 310, 312, 314 so that the nozzle supported by the nozzle coupling will be at a predetermined distance away from the vertical surface.

In some embodiments, the first, second, and third guides 310, 312, 314 are generally circular fixed guides include grooves or channels 316 that can be aligned perpendicular to a radial axis 318 of the guides 306, 308. Referring back to FIG. 2B, in some embodiments, the channels 316 are aligned to the intended direction of movement along the vertical surface that is being cleaned. In some embodiments, the channels 316 are configured with a channel width 320 that passes the cleaning fluid during operation, which considers factors such as the flow rate of the cleaning fluid through the nozzle, the rate that pressure nozzle support is moving vertically up and down during operation, and the viscosity of the cleaning fluid.

In other embodiments, the first, second, and third guides 310, 312, 314 are generally circular fixed guides and have non-slip surfaces that are designed to grip the vertical wall. For example, the first, second, and third guides 310, 312, 314 are generally circular and can have rubber (or similar material) surfaces that are resistant to slipping on the vertical surface.

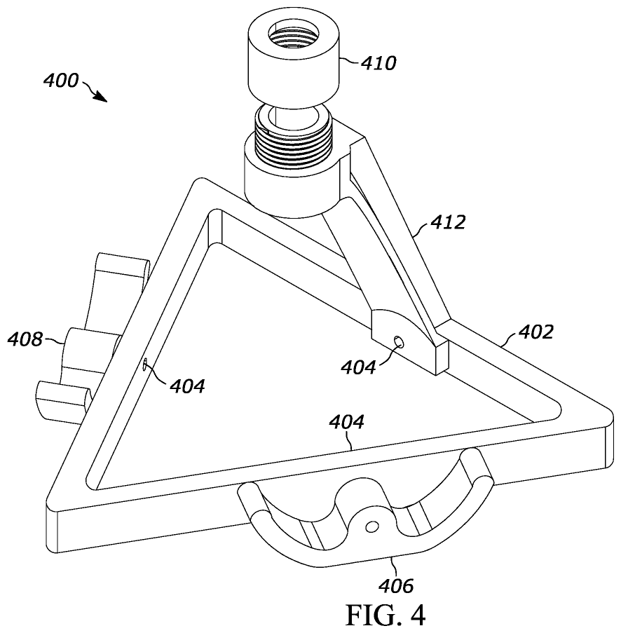

FIG. 4 illustrates an embodiment of a pressure nozzle support 400 for vertical surfaces that includes a triangular-shaped body 402 with various components attached. The pressure nozzle support 400 is similar to the pressure nozzle support 200 described in connection with FIG. 2A. However, the body 402 is triangular-shaped instead of a ring-shaped body. Like the ring-shaped body 202, the body 402 includes a plurality of attachment points 404 that can, for example, be an aperture partially or totally through the body 204 that is compatible with various types of fasteners. Like the body 202 shown in FIG. 2A, the attachment points are through-holes in the body 202 that receive a pin-type or through bolt-type fastener.

The first 406 and second fixed guide 408 are attached to the body 402 at respective attachment points. The first and second guides 406, 408 are formed in a shaped that easily glides along a vertical surface during pressure washing operations as described in connection with FIG. 2A. For example, in the embodiment shown in FIG. 4, the first and second guides 406, 408 are “ski”- or “rocker”-shaped with raised ends.

A nozzle coupling 410 is attached to the body 402 by an arm 412 that is attached at one of the plurality of attachment points 404. The nozzle coupling 410 can also be formed directly in the arm 412 or is attached to the arm 412 by one of numerous types of fasteners. The arm 412 is attached to the body 402 adjacent to the first and second fixed guides 406, 408.

The arm 412 is generally configured to extend the nozzle coupling 410 to a position above the triangular-shaped body 402. Also, like the pressure nozzle support 200 of FIG. 2A, the nozzle coupling 410 is positioned at a height above a bottom surface of each of the first and second fixed guides 406, 408 so that the nozzle supported by the nozzle coupling will be at a predetermined distance away from the vertical surface. In various embodiments, the arm 412 positions the nozzle coupling 410 above the ring-shaped body 402 so that an outlet of a nozzle secured in the nozzle coupling 410 is positioned parallel to the body 402 or at some angle relative to the body 202 where a nozzle secured in the nozzle coupling 410 sprays the pressurize fluid in a desired area on a vertical surface. In many embodiments, the desired area is located within the triangular-shaped body 402 and/or between the first and second fixed guide 406, 408.

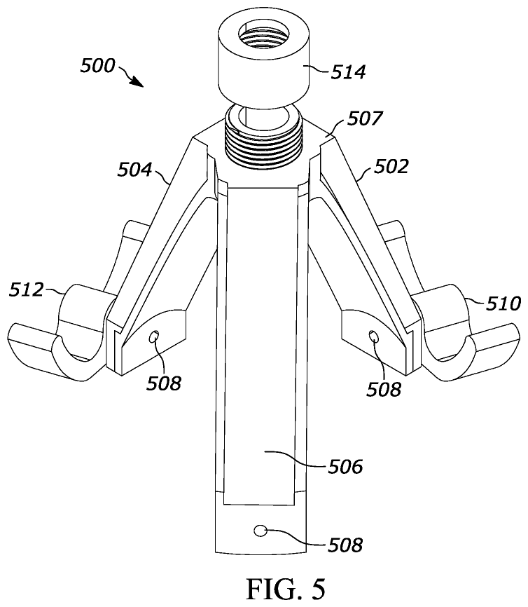

FIG. 5 illustrates an embodiment of a pressure nozzle support 500 for vertical surfaces that includes three arms 502, 504, 506 attached at a first end at a base 507. The pressure nozzle support 500 is similar to the pressure nozzle support 200, 300, 400 described in connection with FIGS. 2, 3, and 4. However, the pressure nozzle support 500 configuration does not include a body. The three arms 502, 504, 506 together form a support structure.

Attachment points 508 are formed at the second end of each of the three arms 502, 504, 506. The attachment points 508 can be an aperture partially or totally through the arm 502, 504, 506 that is compatible with various types of fasteners. The attachment points 508 shown in FIG. 5 are through-holes in the arms 502, 504, 506 that receive a pin-type or through bolt-type fastener.

A first fixed guide 510 is attached to the first end of the first arm 502 at the attachment point 508. A second fixed guide 512 is attached to the first end of the second arm 504 at the attachment point 508. The first and second fixed guides 510, 512 are formed in a shaped that easily glides along a vertical surface during pressure washing operations as described in connection with FIG. 2A. For example, in the embodiment shown in FIG. 5, the first and second guides 510, 512 are “ski”- or “rocker”-shaped with raised ends.

The pressure nozzle support 500 also includes a nozzle coupling 514 attached to the base 507. The arms 502, 504, 506 are generally configured to have a length and angle relative to the base 507 that extends the nozzle coupling 514 to a position above the first and second fixed guides 510, 512 where an outlet of a nozzle secured in the nozzle coupling 514 sprays the pressurize fluid in a desired area on a vertical surface. In many embodiments, the desired area is located within the region defined by the arms 502, 504, 506. In one embodiment, the desired area is located within a center region defined by the arms 502, 504, 506. The nozzle coupling 514 is positioned at a height above a bottom surface of each of the first and second fixed guides 510, 512 so that the nozzle supported by the nozzle coupling will be at a predetermined distance away from the vertical surface.

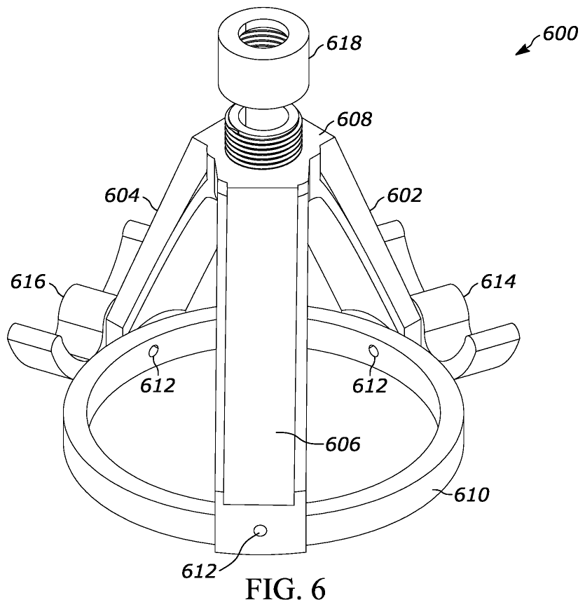

FIG. 6 illustrates an embodiment of a pressure nozzle support 600 for vertical surfaces that includes three arms 602, 604, 606 attached at a first end at a base 608 and attached at a second end to a body 610. The pressure nozzle support 600 is similar to the pressure nozzle support 500 described in connection with FIG. 5. However, the pressure nozzle support 600 configuration does include a body as described in connection with FIGS. 2, 3, and 4. The three arms 602, 604, 606 together form a support structure with the body 610.

Attachment points 612 are formed at the second end of each of the three arms 602, 604, 606. The attachment points 612 can be an aperture partially or totally through the arm 602, 604, 606 that is compatible with various types of fasteners. The attachment points 612 shown in FIG. 6 are through-holes in the arms 602, 604, 606 that receive a pin-type or through bolt-type fastener.

A first fixed guide 614 is attached to the first end of the first arm 602 at the attachment point 612. A second fixed guide 616 is attached to the first end of the second arm 604 at the attachment point 612. The first and second fixed guides 616, 618 are formed in a shaped that easily glides along a vertical surface during pressure washing operations as described in connection with FIG. 2A. For example, in the embodiment shown in FIG. 6, the first and second guides 614, 616 are “ski”- or “rocker”-shaped with raised ends.

The pressure nozzle support 600 also includes a nozzle coupling 618 attached to the base 608. The arms 602, 604, 606 are generally configured to have a length and angle relative to the base 608 that extends the nozzle coupling 618 to a position above the first and second fixed guides 614, 616 where an outlet of a nozzle secured in the nozzle coupling 618 sprays the pressurize fluid in a desired area on a vertical surface. In many embodiments, the desired area is located within the region defined by the arms 602, 604, 606. In one embodiment, the desired area is located within a center region defined by the arms 602, 604, 606. The nozzle coupling 618 is positioned at a height above a bottom surface of each of the first and second fixed guides 614, 616 so that the nozzle supported by the nozzle coupling will be at a predetermined distance away from the vertical surface.

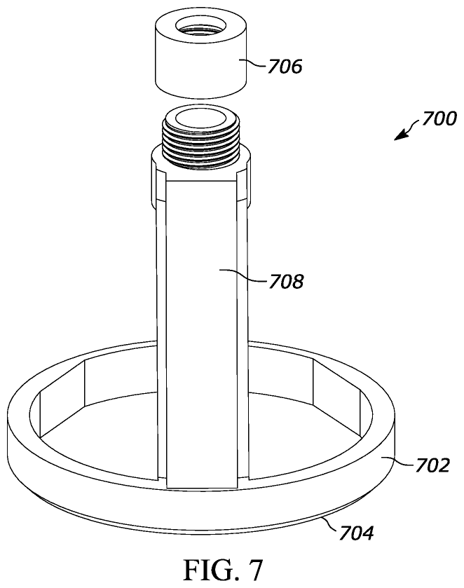

FIG. 7 illustrates an embodiment of a pressure nozzle support 700 for vertical surfaces that includes a frictional bottom surface according to the present teaching. The pressure nozzle support 700 is similar to the pressure nozzle supports described in connection with FIGS. 2A, 2B, and 3 in that it includes a ring-shaped body 702. However, the pressure nozzle support 700 does not include the first and second fixed guides 206, 208 or the first 310, a second 312, and a third guide 314 that are generally circular or ball shaped. Instead, a bottom surface 704 of the body 702 includes a frictional surface, which in some method of use, assists the user in keeping the pressure nozzle support 700 on the vertical surface during use. For example, the bottom surface 704 can be formed of or include a type of weather stripping material. Alternatively, the bottom surface 704 can be formed of a gasket material. Alternatively, the bottom surface 704 can include a grove or recess that receives a gasket, such as an O-ring. The frictional material can be of various thicknesses such as ¼ inch to 1 inch thick.

A nozzle coupling 706 is attached to the body 702 by an arm 708 that is formed in the body 702 or attached at an attachment point. In various embodiments, the nozzle coupling 706 is formed directly in the arm 708 or is attached to the arm 708 by one of numerous types of fasteners. The nozzle coupling 706 is positioned at a height above the body 702 so that the nozzle supported by the nozzle coupling will be at a predetermined distance away from the vertical surface.

One skilled in the art will appreciate that there are numerous configurations of the pressure nozzle support for vertical surfaces according to the present teaching. Some configurations use bodies and others are supported by only the arms as described herein. In various embodiments, the bodies can be a continuous shape, such as a circular-, oval-, or triangular-shaped body or can be a non-continuous shaped, such as an arc. Also, the arms can be flexible or rigid in various configurations depending on the application.

In various embodiments, the guides are attached to the body or arms or are integrated directly into the body or arms. Also, the guides can be shaped so that they glide easily over a vertical surface that may have features such as siding. The guides can be formed of rigid or deformable material. Also, in various embodiments, the guides can be formed of a scratch-resistant material. In some embodiments, the guides are formed of a plastic material.

### EQUIVALENTS

While the Applicant's teaching is described in conjunction with various embodiments, it is not intended that the Applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A pressure nozzle support comprising:
a) a body comprising a plurality of attachment points;
b) a first and second fixed guide, each of the first and second fixed guides being attached to the body at one of the plurality of attachment points and being formed in a shaped that glides along a vertical surface; and
c) a nozzle coupling attached to the body at one of the plurality of attachment points behind the first and second fixed guides, the nozzle coupling being configured to support a nozzle that provides a stream of pressured fluid in a region between the first and second fixed guide and being positioned at a height above a bottom surface of each of the first and second fixed guides so that the nozzle supported by the nozzle coupling will be at a predetermined distance away from the vertical surface.

2. The pressure nozzle support of claim 1 wherein the region between the first and second fixed guide is a center region of the body.

3. The pressure nozzle support of claim 1 wherein the body is formed in a non-continuous shape.

4. The pressure nozzle support of claim 1 wherein a bottom surface of at least one of the first and second fixed guides comprises a channel for passing the fluid.

5. The pressure nozzle support of claim 1 wherein at least one of the first and second fixed guides are formed of a deformable material.

6. The pressure nozzle support of claim 1 wherein at least one of the first and second fixed guides is configured to allow 360 degrees of motion on the vertical surface.

7. The pressure nozzle support of claim 1 wherein at least one of the first and second fixed guides is configured to allow omni-directional motion in three dimensions.

8. A pressure nozzle support comprising:
a) a body;
b) a first and second fixed guide, each of the first and second fixed guides being formed into the body and being shaped to glide along a vertical surface; and
c) a nozzle coupling formed in the body behind the first and second fixed guides, the nozzle coupling being configured to support a nozzle that provides a stream of pressured fluid in a region between the first and second fixed guide and being positioned at a height above a bottom surface of each of the first and second fixed guides so that the nozzle supported by the nozzle coupling will be at a predetermined distance away from the vertical surface.

9. The pressure nozzle support of claim 8 wherein the region between the first and second fixed guide is a center region of the body.

10. The pressure nozzle support of claim 8 wherein the body is formed in a non-continuous shape.

11. The pressure nozzle support of claim 8 wherein a bottom surface of at least one of the first and second fixed guides comprises a channel for passing the fluid.

12. The pressure nozzle support of claim 8 wherein at least one of the first and second fixed guides are formed of a deformable material.

13. The pressure nozzle support of claim 8 wherein at least one of the first and second fixed guides is configured to allow 360 degrees of motion on the vertical surface.

14. The pressure nozzle support of claim 8 wherein at least one of the first and second fixed guides is configured to allow omni-directional motion in three dimensions.

15. A pressure nozzle support comprising:
a) a nozzle coupling being configured to support a nozzle that provides a stream of pressured fluid to a vertical surface;
b) a first fixed guide attached to the nozzle coupling such that a distance from a bottom surface of the first fixed guide to the nozzle supported by the nozzle coupling will be at a predetermined distance away from the vertical surface, the first fixed guide being formed in a shaped that glides along the vertical surface; and
c) a second fixed guide attached to the nozzle coupling such that a distance from a bottom surface of the second fixed guide to the nozzle supported by the nozzle coupling will be at the predetermined distance away from the vertical surface, the second fixed guide being formed in a shaped that glides along the vertical surface, wherein the nozzle coupling is aligned relative to the first and second fixed guide so that the nozzle supported by the nozzle coupling provides a stream of pressured fluid in a region defined by the first and second fixed guide.

16. The pressure nozzle support of claim 15 wherein the nozzle coupler is aligned relative to the first and second fixed guide so that the nozzle supported by the nozzle coupler provides a stream of pressured fluid in a center region defined by the first and second fixed guide.

17. The pressure nozzle support of claim 15 wherein a bottom surface of at least one of the first and second fixed guides comprises a channel for passing the fluid

18. The pressure nozzle support of claim 15 wherein at least one of the first and second fixed guides is positioned such that the distance from the bottom surface of the at least one of the first and second fixed guide to the nozzle supported by the nozzle coupling will be at the predetermined distance away from the vertical surface with a flexible member.

19. The pressure nozzle support of claim 15 wherein at least one of the first and second fixed guides is configured to allow 360 degrees of motion on the vertical surface.

20. The pressure nozzle support of claim 15 wherein at least one of the first and second fixed guides is configured to allow omni-directional motion in three dimensions.
